(19) United States
(12) Patent Application Publication
(10) Pub. No.: US 2026/0108899 A1
(43) Pub. Date: Apr. 23, 2026

(54) Electric Spray Gun Body with Top-Mounted Amplitude Adjustment Structure

(71) Applicants: Junpeng Wei, Taizhou (CN); Zhenxing Ying, Taizhou (CN); FaZheng Yang, Taizhou (CN); Xiaopeng Li, Taizhou (CN)

(72) Inventors: Junpeng Wei, Taizhou (CN); Zhenxing Ying, Taizhou (CN); FaZheng Yang, Taizhou (CN); Xiaopeng Li, Taizhou (CN)

(21) Appl. No.: 18/922,454

(22) Filed: Oct. 22, 2024

(51) Int. Cl. B05B 5/025; B05B 5/06; B05B 7/24; B05B 12/16

(52) U.S. Cl. CPC B05B 5/025; B05B 5/06; B05B 7/2489; B05B 12/16

(57) ABSTRACT

A gun body for an electric spray gun with an amplitude adjustment structure positioned on top, comprising a gun body, a material container, a nozzle assembly, and a material needle. The gun body includes a first channel, a second channel, a third channel, and a coating channel, with an amplitude adjustment assembly installed on the gun body. The nozzle assembly has a primary atomization channel and a secondary atomization channel. The primary atomization channel, and the interior of the material container, while the third channel is connected to the coating channel. The amplitude adjustment assembly controls the communication between the first and second channels and adjusts the gap size between them. The gun body not only allows switching between circular and elliptical spray patterns but also controls the gap size between the first and third channels during the rotation of the amplitude adjustment knob.

### FIELD OF THE INVENTION

The present invention relates to the technical field of spray guns, specifically to an electric spray gun body with a top-mounted amplitude adjustment structure.

### BACKGROUND OF THE INVENTION

A spray gun is a tool used for paint spraying. It utilizes rapidly released compressed air as power to eject paint from the nozzle. The design between the nozzle and the needle rod is particularly important for the spraying effect.

Electric spray guns need to atomize paint into different shapes according to various spraying requirements. Existing electric spray guns atomize paint into circular and certain lengths of elliptical shapes. During the transition from circular to elliptical shapes, the atomization length cannot be adjusted arbitrarily according to actual spraying needs. Moreover, electric spray guns with amplitude adjustment functions have complex structures and high production costs. Therefore, there is a need to improve the amplitude adjustment function structure on existing electric spray guns.

### SUMMARY OF THE INVENTION

The purpose of this utility model is to solve the problems raised in the above background technology and provide an electric spray gun body structure with a top-mounted amplitude adjustment structure.

To achieve the above purpose, the technical solution of this utility model is: An electric spray gun body structure with a top-mounted amplitude adjustment structure, comprising a gun body, a material pot, a nozzle assembly, and a material needle; the gun body is respectively provided with a first passage, a second passage, a third passage, and a paint passage, and the gun body is simultaneously equipped with an amplitude adjustment assembly; the nozzle assembly is respectively provided with a main atomization passage and an auxiliary atomization passage; the first passage is respectively connected with the motor air outlet, the main atomization passage, and the inside of the material pot, the third passage communicates with the paint passage, and the amplitude adjustment assembly controls the communication between the first passage and the second passage, as well as the adjustment of the communication gap size, thereby realizing the control of the air opening and closing of the auxiliary atomization passage and the adjustment of the air volume.

In the above electric spray gun body structure with a top-mounted amplitude adjustment structure, the amplitude adjustment assembly includes an amplitude adjustment knob, an amplitude adjustment screw plug, and an amplitude adjustment screw seat. The amplitude adjustment screw seat is fixedly connected with the gun body, the amplitude adjustment screw plug is threadedly and rotatably connected with the amplitude adjustment screw seat, and the amplitude adjustment knob is connected with the amplitude adjustment screw seat. The gun body is provided with multiple air holes that connect the first passage and the second passage. The rotation of the amplitude adjustment screw plug controls the opening and closing of the air holes and the size of the opening gap, thereby controlling the communication between the first passage and the second passage, and between the auxiliary atomization passage, realizing the control of the air opening and closing of the auxiliary atomization passage and the adjustment of the air volume through the rotation of the amplitude adjustment screw plug.

In the above electric spray gun body structure with a top-mounted amplitude adjustment structure, the gun body is provided with an installation hole for installing the amplitude adjustment assembly. The bottom of the installation hole is provided with a tapered hole, which communicates with the end of the second passage and the air holes. The end of the amplitude adjustment screw plug is provided with a control plate, and the side of the control plate is provided with a tapered surface matching the tapered hole. The control plate controls the air opening and closing and the air volume adjustment between the first passage and the second passage through the control plate.

In the above electric spray gun body structure with a top-mounted amplitude adjustment structure, the first passage and the second passage are arranged on the same central axis, the amplitude adjustment assembly is arranged on the upper position of the gun body, and the central axis of the installation hole is set perpendicular to the central axes of the first passage and the second passage.

In the above electric spray gun body structure with a top-mounted amplitude adjustment structure, the amplitude adjustment screw plug is provided with a positioning boss, and a disc spring is arranged at the contact between the positioning boss and the amplitude adjustment screw seat.

In the above electric spray gun body structure with a top-mounted amplitude adjustment structure, the gun body is provided with a material pot air inlet hole, and the first passage communicates with the inside of the material pot through the material pot air inlet hole.

In the above electric spray gun body structure with a top-mounted amplitude adjustment structure, a duckbill valve is arranged at the end of the material pot air inlet hole communicating with the material pot.

In the above electric spray gun body structure with a top-mounted amplitude adjustment structure, the third passage communicates with the material pot through a material pipe.

In the above electric spray gun body structure with a top-mounted amplitude adjustment structure, the nozzle assembly includes an atomization cap, a fixing cap, and a nozzle body. The fixing cap fixes the nozzle assembly on the gun body, the nozzle body and the atomization cap form the auxiliary atomization passage and the main atomization passage, and the second passage communicates with the auxiliary atomization passage and the upper side air hole of the atomization cap.

By adopting the above technical solution, the present invention has the following beneficial effects:

Through the rotational action of the amplitude adjustment knob in the amplitude adjustment assembly, the amplitude adjustment screw plug is driven to move. The amplitude adjustment screw plug controls the communication between the first passage and the second passage, as well as the adjustment of the communication gap size, thereby controlling the air opening and closing of the auxiliary atomization passage and the adjustment of the air volume. This not only realizes the switching between circular and elliptical spraying shapes but also controls the size of the communication gap between the first passage and the second passage during the rotation of the amplitude adjustment screw plug. When the paint switches from a circular to an elliptical shape, the atomization length of the elliptical shape can be adjusted arbitrarily according to actual requirements. The present invention has a simple structure and is very convenient to operate and use.

### BRIEF DESCRIPTION OF THE DRAWINGS

FIG. 1 is a perspective view of the present invention;

FIGS. 2 and 3 are perspective sectional views of the present invention from two different directions;

FIG. 4 is a planar sectional view of the present invention;

FIG. 5 is a perspective sectional view of the gun body in the present invention;

FIG. 6 is a perspective view of the amplitude adjustment screw plug in the present invention.

### DETAILED DESCRIPTION OF THE EMBODIMENTS

The present invention is further described in conjunction with the drawings.

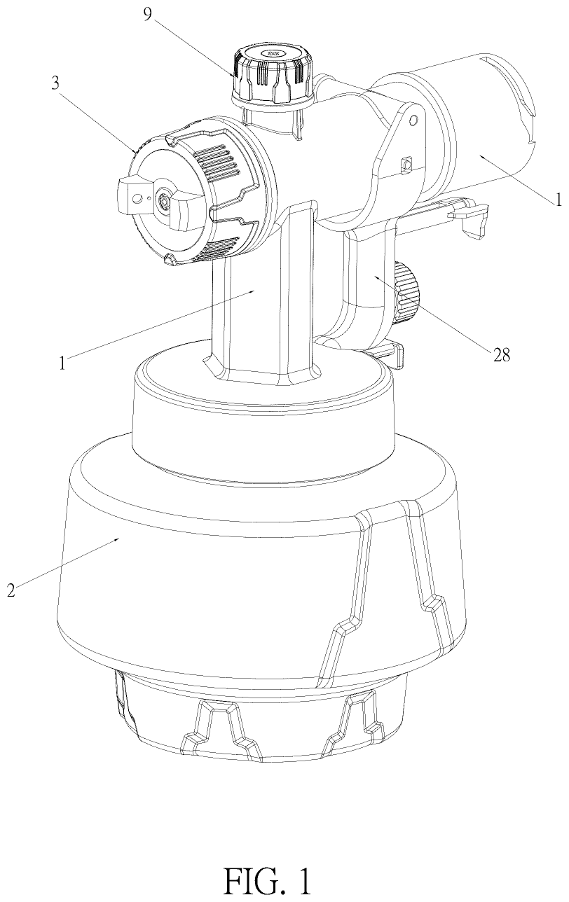

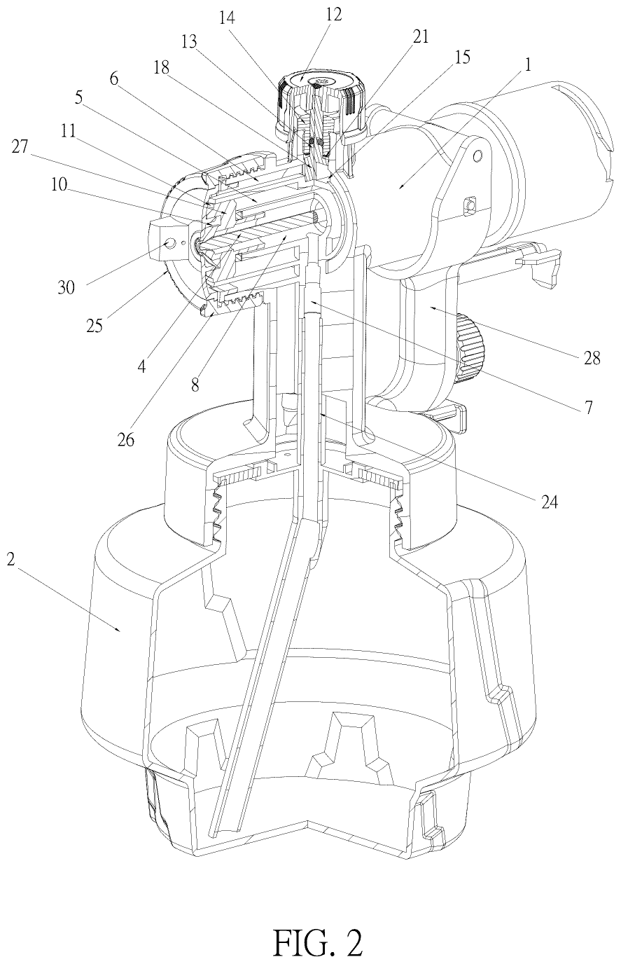

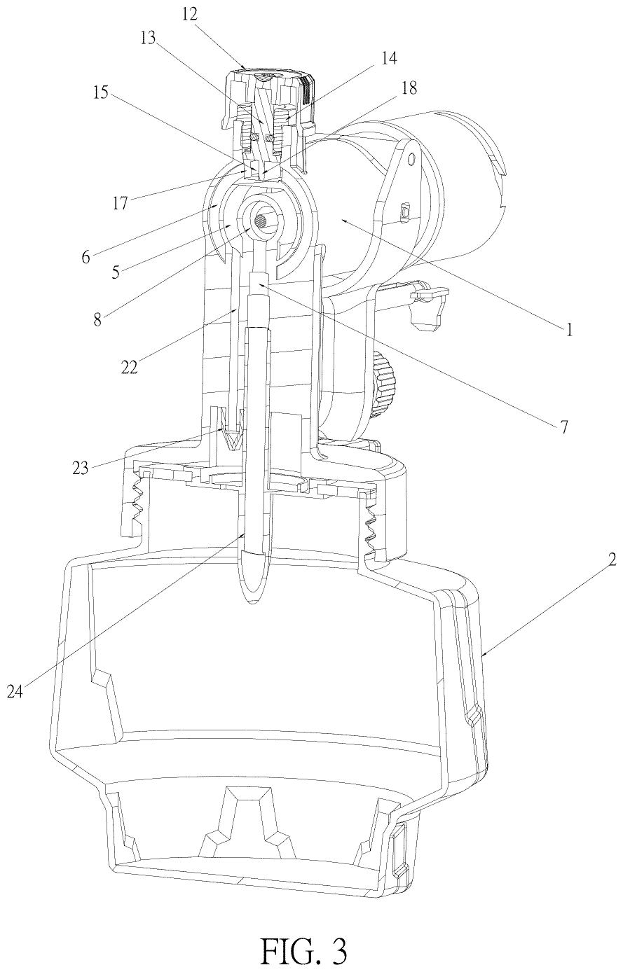

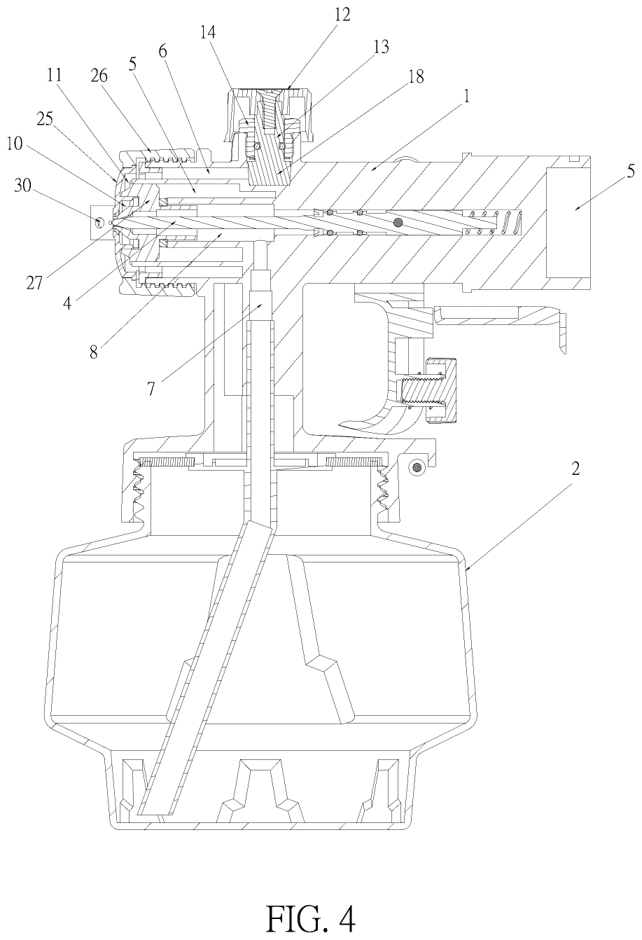

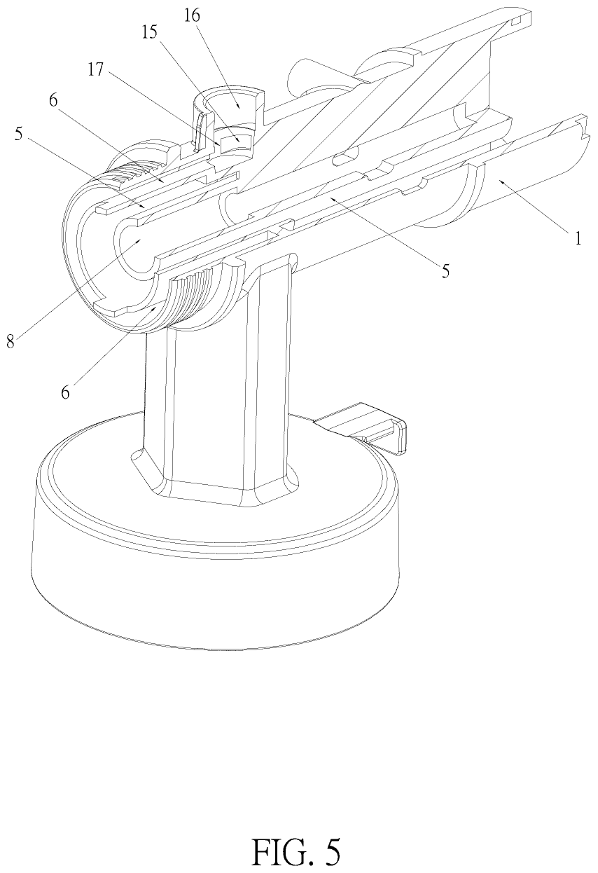

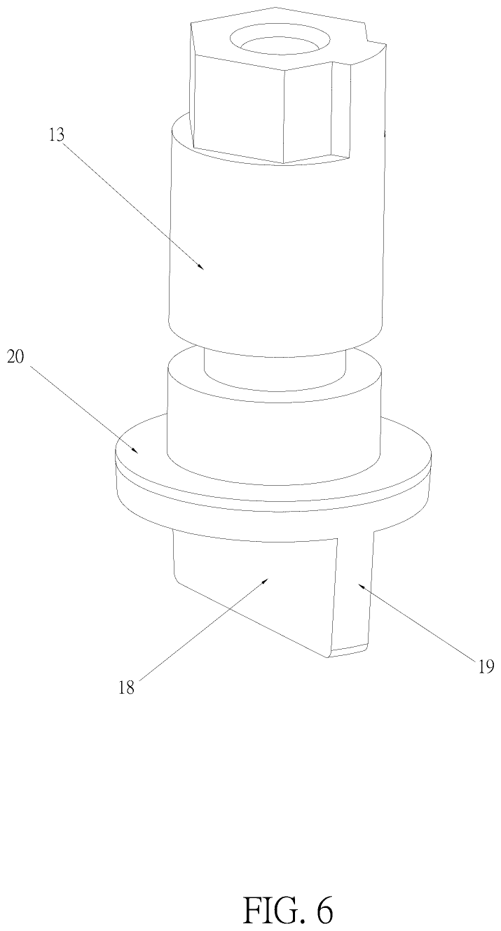

Please refer to FIGS. 1 to 6. The present invention provides an electric spray gun body structure with a top-mounted amplitude adjustment structure, comprising a gun body (1), a material pot (2), a nozzle assembly (3), and a material needle (4). The gun body (1) is respectively provided with a first passage (5), a second passage (6), a third passage (7), and a paint passage (8), and the gun body (1) is simultaneously equipped with an amplitude adjustment assembly (9).

The nozzle assembly (3) includes an atomization cap (25), a fixing cap (26), and a nozzle body (27). The fixing cap (26) fixes the nozzle assembly (3) on the gun body (1). The nozzle body (27) and the atomization cap (25) form an auxiliary atomization passage (11) and a main atomization passage (10). The second passage (6) communicates with the auxiliary atomization passage (11) and the upper side air hole (30) of the atomization cap (25).

The first passage (5) respectively communicates with the motor air outlet, the main atomization passage (10), and the inside of the material pot (2). The third passage (7) communicates with the paint passage (8). The amplitude adjustment assembly (9) controls the communication between the first passage (5) and the second passage (6), as well as the adjustment of the communication gap size.

The amplitude adjustment assembly (9) includes an amplitude adjustment knob (12), an amplitude adjustment screw plug (13), and an amplitude adjustment screw seat (14). The gun body (1) is provided with an installation hole (16) for installing the amplitude adjustment assembly (9). The amplitude adjustment screw seat (14) is fixedly connected with the installation hole (16) of the gun body (1). The amplitude adjustment screw plug (13) is threadedly and rotatably connected with the amplitude adjustment screw seat (14), and the amplitude adjustment knob (12) is connected with the amplitude adjustment screw seat (14). The gun body (1) is provided with multiple air holes (15) that connect the first passage (5) and the second passage (6). The bottom of the installation hole (16) is provided with a tapered hole (17), which communicates with the end of the second passage (6) and the air holes (15). The end of the amplitude adjustment screw plug (13) is provided with a control plate (18), and the side of the control plate (18) is provided with a tapered surface (19) matching the tapered hole (17). Specifically, when the amplitude adjustment screw plug (13) rotates, the control plate (18) controls the opening and closing of multiple air holes (15) and the size of the opening gap, thereby controlling the communication between the first passage (5) and the second passage (6), and between the auxiliary atomization passage (11). Thus, by rotating the amplitude adjustment screw plug (13), the air opening and closing of the auxiliary atomization passage (11) and the adjustment of the air volume are realized.

Preferably, the first passage (5) and the second passage (6) are arranged on the same central axis. The amplitude adjustment assembly (9) is arranged at the upper position of the gun body (1), and the central axis of the installation hole (16) is set perpendicular to the central axes of the first passage (5) and the second passage (6).

Furthermore, the amplitude adjustment screw plug (13) is provided with a positioning boss (20), and a disc spring (21) is arranged at the contact between the positioning boss (20) and the amplitude adjustment screw seat (14). The disc spring (21) ensures the smooth rotation of the amplitude adjustment screw plug (13) and guarantees the sealing performance when the control plate (18) on the amplitude adjustment screw plug (13) is matched with the tapered hole (17) in the closed state.

Furthermore, the gun body (1) is provided with a material pot air inlet hole (22), and the first passage (5) communicates with the inside of the material pot (2) through the material pot air inlet hole (22).

Furthermore, a duckbill valve (23) is arranged at the end of the material pot air inlet hole (22) communicating with the material pot (2), and the third passage (7) communicates with the material pot (2) through a material pipe (24).

The working principle of the present invention is further introduced as follows:

When in use, the rear end of the gun body (1) is connected to and installed with a motor, and the motor air outlet corresponds and connects with the first passage. During operation, pulling the trigger (28) opens the switch, causing the motor in the spray gun to start working, and simultaneously, the material needle (4) moves backward to open the paint passage (8) at the nozzle body (27). The operation of the motor causes air to flow through the first passage (5) into the gun body. When the amplitude adjustment knob (12) is tightened and closed, air passes from the first passage (5) in the gun body through the material pot air inlet hole (22) and the duckbill valve (23) into the material pot (2). Due to the pressure, the paint is pressed through the material pipe into the paint passage (8) in the gun body and reaches the nozzle body (27) opening. Simultaneously, air passes from the first passage (5) in the gun body through the main atomization passage (10) to produce a siphon and atomization effect on the paint at the nozzle body opening. At this time, the paint is uniformly atomized and sprayed onto the object being sprayed, and the paint is atomized into a circular shape. When the amplitude adjustment knob (12) is rotated to open, the amplitude adjustment knob drives the amplitude adjustment screw plug (13) to move, and the amplitude adjustment screw plug allows the air holes (15) on the gun body to communicate with the second passage (6). Air is diverted from the first passage (5) in the gun body into the second passage (6), and air flows through the second passage into the auxiliary atomization passage (11). The main atomization passage (10) and the auxiliary atomization passage (11) produce a siphon and atomization effect on the paint, and the air communicating with the upper side air hole (30) of the atomization cap (25) compresses the paint, causing the atomized paint to form an elliptical shape. Rotating the amplitude adjustment knob to different angles, the control plate (18) on the amplitude adjustment screw plug controls different gaps between the air holes (15) and the second passage (6). The larger the rotation angle, the larger the gap, and the longer the paint atomization length; conversely, the shorter the spray width. When the gap is zero, the spray shape is circular.

The above provides a detailed description of an electric spray gun body structure with a top-mounted amplitude adjustment structure provided by the embodiments of this utility model. In this document, specific examples are used to explain the principles and implementation methods of the present invention. The description of the above embodiments is only to help understand the technical solution disclosed by the present invention. Meanwhile, for those skilled in the art, there will be variations in the specific implementation methods and application scopes according to the ideas of the present invention. In summary, the content of this specification should not be construed as limiting the present invention.

We claim

1. An electric spray gun body with a top-mounted amplitude adjustment structure, comprising:
a gun body (1), a material pot (2), a nozzle assembly (3), and a material needle (4);
wherein the gun body (1) is respectively provided with a first passage (5), a second passage (6), a third passage (7), and a paint passage (8), and the gun body (1) is simultaneously equipped with an amplitude adjustment assembly (9);
the nozzle assembly (3) is respectively provided with a main atomization passage (10) and an auxiliary atomization passage (11);
the first passage (5) respectively communicates with a motor air outlet, the main atomization passage (10), and the inside of the material pot (2), the third passage (7) communicates with the paint passage (8), and the amplitude adjustment assembly (9) controls the communication between the first passage (5) and the second passage (6), as well as the adjustment of the communication gap size, thereby realizing the control of the air opening and closing of the auxiliary atomization passage (11) and the adjustment of the air volume.

2. The electric spray gun body with the top-mounted amplitude adjustment structure according to claim 1, wherein the amplitude adjustment assembly (9) includes an amplitude adjustment knob (12), an amplitude adjustment screw plug (13), and an amplitude adjustment screw seat (14), the amplitude adjustment screw seat (14) is fixedly connected with the gun body (1), the amplitude adjustment screw plug (13) is threadedly and rotatably connected with the amplitude adjustment screw seat (14), and the amplitude adjustment knob (12) is connected with the amplitude adjustment screw seat (14); the gun body (1) is provided with multiple air holes (15) that connect the first passage (5) and the second passage (6), and the rotation of the amplitude adjustment screw plug (13) controls the opening and closing of the air holes (15) and the size of the opening gap, thereby controlling the communication between the first passage (5) and the second passage (6), and between the auxiliary atomization passage

(11) realizing the control of the air opening and closing of the auxiliary atomization passage (11) and the adjustment of the air volume through the rotation of the amplitude adjustment screw plug (13).

3. The electric spray gun body with the top-mounted amplitude adjustment structure according to claim 2, wherein the gun body (1) is provided with an installation hole (16) for installing the amplitude adjustment assembly (9), the bottom of the installation hole (16) is provided with a tapered hole (17), which communicates with the end of the second passage (6) and the air holes (15), the end of the amplitude adjustment screw plug (13) is provided with a control plate (18), and the side of the control plate (18) is provided with a tapered surface (19) matching the tapered hole (17), and the control plate (18) controls the air opening and closing and the air volume adjustment between the first passage (5) and the second passage (6) through the control plate (18).

4. The electric spray gun body with the top-mounted amplitude adjustment structure according to claim 2, wherein the first passage (5) and the second passage (6) are arranged on the same central axis, the amplitude adjustment assembly (9) is arranged at the upper position of the gun body (1), and the central axis of the installation hole (16) is set perpendicular to the central axes of the first passage (5) and the second passage (6).

5. The electric spray gun body with the top-mounted amplitude adjustment structure according to claim 2, wherein the amplitude adjustment screw plug (13) is provided with a positioning boss (20), and a disc spring (21) is arranged at the contact between the positioning boss (20) and the amplitude adjustment screw seat (14).

6. The electric spray gun body with the top-mounted amplitude adjustment structure according to claim 1, wherein the gun body (1) is provided with a material pot air inlet hole (22), and the first passage (5) communicates with the inside of the material pot (2) through the material pot air inlet hole (22).

7. The electric spray gun body with the top-mounted amplitude adjustment structure according to claim 6, wherein a duckbill valve (23) is arranged at the end of the material pot air inlet hole (22) communicating with the material pot (2).

8. The electric spray gun body with the top-mounted amplitude adjustment structure according to claim 1, wherein the third passage (7) communicates with the material pot (2) through a material pipe (24).

9. The electric spray gun body with the top-mounted amplitude adjustment structure according to claim 1, wherein the nozzle assembly (3) includes an atomization cap (25), a fixing cap (26), and a nozzle body (27), the fixing cap (26) fixes the nozzle assembly (3) on the gun body (1), the nozzle body (27) and the atomization cap (25) form the auxiliary atomization passage (11) and the main atomization passage (10), and the second passage (6) communicates with the auxiliary atomization passage (11) and the upper side air hole (30) of the atomization cap (25).
